(19) United States
(12) Patent Application Publication
(10) Pub. No.: US 2008/0172719 A1
(43) Pub. Date: Jul. 17, 2008

(54) METHOD AND APPARATUS FOR REALIZING ACCURATE BILLING IN DIGITAL RIGHTS MANAGEMENT

(75) Inventors: Jianyu ZHANG, Guangdong Province (CN); Donghang Chen, Guangdong Province (CN)

Correspondence Address: LADAS & PARRY, 5670 WILSHIRE BOULEVARD, SUITE 2100, LOS ANGELES, CA, 90036-5679, US

(73) Assignee: HUAWEI TECHNOLOGIES CO., LTD., Guangdong Province (CN)

(21) Appl. No.: 12/041,512

(22) Filed: Mar. 3, 2008

Related U.S. Application Data
(63) Continuation of application No. PCT/CN2006/002836, filed on Oct. 24, 2006.

(30) Foreign Application Priority Data
Nov. 21, 2005 (CN) 200510123462.3

(51) Int. Cl. G06F 21/00

(52) U.S. Cl. 726/1

(57) ABSTRACT

The present invention discloses a method for realizing accurate billing in digital rights management, including: sending, by a rights issuing system, to a Device a rights object acquisition response message including a rights object; sending, by the Device, a rights object acquisition acknowledgement message to the rights issuing system, after validation of the rights object acquisition response message is passed; and initiating, by the rights issuing system, a billing function after receiving the rights object acquisition acknowledgement message. The invention also discloses an apparatus and a rights issuing system. With the inventive method and system, billing will be initiated only in the event that the Device has obtained the rights object successfully or has joined the domain successfully, thereby avoiding effectively the problem of billing error and improving the Quality of Service.

The present application is a continuation of PCT application PCT/CN2006/002836, filed on Oct. 24, 2006, entitled “A METHOD FOR CHARGING PRECISELY IN THE DIGITAL RIGHTS MANAGEMENT AND A DEVICE THEREOF”, which is incorporated by reference herein in its entirety.

### FIELD OF THE INVENTION

The present invention relates to a digital rights management technology, and in particular to a method and apparatus for realizing accurate billing in digital rights management.

### BACKGROUND OF THE INVENTION

The OMA Digital Rights Management (DRM) enables a content provider to specify the way of how to consume a media object, and a DRM system is independent of a media object format and a specific operation system/runtime system. A media object controllable by the DRM may be various contents, such as game, ring tone, image, music clip, video clip, stream media, etc. The content provider can grant a user-corresponding right for each media object. The contents are encrypted for protection and distributed, and the user can use the protected contents on a Device only after the right has been purchased.

The protected contents can be issued to a Device in any way, such as via air interface, local connection, removable medium, etc., but a rights object (RO) can be controlled and distributed only by a rights issuer. The protected contents and the rights object can be downloaded to a Device simultaneously, or can be sent to a Device separately. The DRM system does not specify a downloading order or binding of the protected contents and the rights object.

The specification of OMA DRM 2.0 defines formats, semantics, etc. regarding encryption protocols, messages, processing instructions and certificates, all of which together enable establishment of an end-to-end digital content protection system.

The Rights Object Acquisition Protocol (ROAP) generally refers to a DRM security protocol suite between the Rights Issuer (RI, also referred to as a rights issuing system) and a DRM proxy in a Device. This protocol suite includes a 4-pass protocol, for registration of a Device on the rights issuing system; a 2-pass protocol, for acquisition of a rights object, including a request for and the distribution of the rights object; and a 1-pass protocol, for acquisition of a rights object, which only includes the distribution of the rights object from the rights issuing system to the Device (such as messaging or pushing).

The 2-pass rights object acquisition protocol involves mutual authentication of the Device and the rights issuing system, a request for protection of integrity, transmission of rights object, and secure transmission of a private key required for handling rights object, and this protocol is successfully executed on a premise that the Device and the rights issuer establish a rights issuing system context in advance. An implementation of the 2-pass protocol is illustrated in FIG. 1.

The mode of 1-pass protocol is to satisfy the use of messaging/push, and when this protocol is to be used, a security union should have been established between the Device and the rights issuing system. An implementation of the 1-pass protocol is as illustrated in FIG. 2.

Different from the 2-pass rights object acquisition protocol, the 1-pass protocol is initiated unilaterally by the right issuing system, and no information needs to be sent back from the Device. A typical application scenario is regularly distributing rights object, such as a support for content subscription. The 1-pass is substantially the last message of the 2-pass.

Acquisition of a rights object in ROAP is accomplished primarily through the 2-pass rights object acquisition protocol or the 1-pass rights object acquisition protocol. And the protocols are successfully executed on the condition that the Device and the rights issuing system establish a rights issuing system context in advance. During the acquisition of a rights object by the ROAP 2-pass, the Device sends the information of a requested rights object as a parameter of ROAP-RORequest message to the rights issuing system, and the rights issuing system returns the rights object as a parameter of ROAP-ROResponse message. During the acquisition of a rights object with the ROAP 1-pass, the rights issuing system initiatively sends the rights object as a parameter of ROAP-ROResponse message to the Device. The messages are transmitted with HTTP, and the transfer layer is based on TCP, the procedure of which will be described hereinafter.

1. A Device sends a Rights Object Acquisition Request message (ROAP-RORequest) to the rights issuing system, which is the first message issued by the 2-pass rights object acquisition protocol.

2. The rights issuing system sends a Rights Object Acquisition Response message (ROAP-ROResponse) to the Device, which may be a response message responding to the ROAP-RORequest message (a 2-pass variable) or a message initiated initiatively by the rights issuing system (a 1-pass variable), and carries a protected rights object. Through the ROAP 2-pass rights object acquisition procedure or the ROAP 1-pass rights object acquisition procedure, the rights object is transmitted from the rights issuing system to the Device. For the ROAP-ROResponse message and the rights object with a signature, the Device should check the signature. The signature verification should include the verification of all the certificates in the rights issuer (RI) certificate chain, as well as the verification of the revoke status of all the revocable certificates in the certificate chain. Only during the installation of the domain RO, the verification of the revoke status may be skipped. In order to enable the Device to verify the certificate status, when the RI sends a response with signature to the Device, the Online Certificate State Protocol (OCSP) response of all the revocable certificates in the certificate chain should be included, unless the parameters of the request message sent by the Device indicate that a valid OCSP response is buffered for the RI by the Device. If the parameters of the request message sent by the Device indicate that a valid OCSP response is buffered for the RI by the Device, the RI does not need to send the OCSP response. Otherwise, the Device should check whether the ROAP response message includes the OCSP response. If not, the Device should stop the ROAP protocol. Only when the validation on the Signature in the ROAP-ROResponse message succeeds, the identity of the rights issuing system is validated successfully, and the certificate of the rights issuing system is available, the Device determines that the rights object acquisition protocol has been executed successfully; otherwise the Device can not install the received rights object

A domain is a set of Devices sharing a domain private key provided by the rights issuing system, and the Devices in the domain may share a domain rights object, and consume and share any digital content controlled by the domain rights object.

The concept of OMA DRM domain is network-centered, and the rights issuing system defines a domain, a management domain private key, and the situation in which a Device is controlled to join or leave a domain. A user may request adding a Device into a domain before obtaining contents related to the domain, or send a request for joining the domain after obtaining the content related to the domain.

To join a domain, the Device should first establish a rights issuing system context as a part of a successful join domain protocol. The procedure in which a Device joins a domain is a procedure in which the rights issuing system authorizes a specific Device to use all rights objects in the domain. Upon joining the domain, the Device receives information necessary for enabling installation of a domain rights object.

The Device executes the join domain protocol when joining a domain. A successful execution of the join domain protocol enables the Device to establish a Domain Context of a given domain. The domain context includes information such as domain private key, domain identifier, expiration time, etc.

The Device may join a plurality of domains managed by one or more rights issuing systems. If a domain which the Device joins has derivative generations from a plurality of domains (i.e. a domain which has issued more than one version of domain private key), then the rights issuing system shall send all domain private keys generated by that domain to the Device, and permit the Device to use all rights objects in the domain. However, if both the Device and the rights issuing system use a hash chain mechanism (that is, an association is established between different domain private keys with a hash chain), then the rights issuing system is only required to provide a domain private key of the latest version.

The 2-pass join domain protocol is a request/response protocol initiated by a Device, for requesting joining a domain where the rights issuing system has been defined, and receiving a domain private key and other information required for sharing a rights object in the domain (in the case of a successful request) or error information (in the case of a failed request). This protocol assumes that there exists a rights issuing system context already. The 2-pass join domain protocol is as illustrated in FIG. 3.

After successful execution of the join domain protocol, a domain context is established in the Device, including domain-specific security-related information including domain private key. The domain context is necessary for the Device to install and use a rights object in the domain.

In ROAP, joining a domain is accomplished primarily through the 2-pass join domain protocol. A Device sends to the rights issuing system the domain identifier of a domain that the Device applied for joining as a parameter of ROAP-JoinDomainRequest message. In the case of a successful execution, the rights issuing system returns, to the Device, domain information including domain private key and expiration time, as a parameter of ROAP-JoinDomain Response message. These messages are transmitted through HTTP, and the transfer layer is based on TCP. The successful execution of the join domain protocol enables the Device to establish a domain context of a given domain. The procedure of the execution of the join domain protocol will be described hereinafter.

1. A Device sends a join domain request message (ROAP-JoinDomainRequest) to the rights issuing system.

The ROAP-JoinDomainRequest message is transmitted from the rights issuing system to the Device, and is the first message of the 2-pass join domain protocol. The ROAP-JoinDomainRequest message only supports a request for joining a single domain.

2. The rights issuing system sends to the Device a join domain response message (ROAP-JoinDomainResponse), for responding to the ROAP-JoinDomainRequest message. The JoinDomain response message is the second message in the 2-pass protocol for the Device to join a domain.

With the procedure of joining a domain through the ROAP 2-pass, the domain information including domain private key and expiration time is transmitted from the rights issuing system to the Device. Only in the event that the validation on a signature in the ROAP-JoinDomainRequest message succeeds, an identity of the rights issuing system is validated successfully, and a certificate of the rights issuing system is available, the Device determines that the join domain protocol has been executed successfully; otherwise, the Device can not store the received Domain Information so as to establish a Domain Context. Upon successfully joining the domain, the Device establishes a domain context corresponding to the domain, and thus can install a domain rights object and obtain the right of consuming and sharing digital contents controlled by any domain rights object.

During the acquisition of a rights object, only in the event that a validation on the Signature in the ROAP-ROResponse message succeeds, an identity of the rights issuing system is validated successfully, and a certificate of the rights issuing system is available, the Device determines that the rights object acquisition protocol has been executed successfully; otherwise, the Device can neither install nor use the received rights object. However, in this procedure, a case may occur in which the rights issuing system has sent the ROAP-ROResponse message to the Device, but the Device receives no rights object or the received rights object can not be used. Due to a lack of an acknowledgement mechanism at the application layer, the rights issuing system initiates operations of billing, statistics, etc. if no transmission error occurs after a rights object is sent. In such case, the user has paid but not consumed digital contents in the domain, and thus the billing becomes inaccurate.

Since the Device which joins a domain can share a domain rights object, and consume and share digital contents controlled by any domain rights object, the rights issuing system may regard as a possible mode the charging for successful joining a domain by a Device. Since only in the event that the validation on a signature in the ROAP-JoinDomainRequest message succeeds, an identity of the rights issuing system is validated successfully, and a certificate of the rights issuing system is available, the Device may determine that the join domain protocol has been executed successfully, and thus install a domain context, and install a rights object in accordance with the information in the domain context. In this procedure of joining a domain, a case may occur in which the rights issuing system has sent the ROAP-JoinDomainResponse message to the Device, but the Device receives no Domain Information including domain private key and expiration time, or the received context information can not be used for establishing a domain context. Due to a lack of an acknowledgement mechanism at the application layer, the rights issuing system initiates operations of billing, statistics, etc. (in the above mode) if no transmission error occurs after domain information including domain private key and expiration time is sent. At this moment, the user has paid but not obtained the right of consuming shared digital contents in the domain, and thus the billing becomes inaccurate.

### SUMMARY OF THE INVENTION

Embodiments of the invention provide a method, an apparatus and a rights issuing system for realizing accurate billing in digital rights management, so that a possible problem in the prior art that a user who obtains no right of consuming digital contents may be charged can be resolved.

To attain the above object, an embodiment of the invention provides a method for realizing accurate billing in digital rights management, including:

sending, by a rights issuing system, to a Device a rights object acquisition response message including a rights object;

sending, by the Device, a rights object acquisition acknowledgement message to the rights issuing system, after validation of the rights object acquisition response message is passed; and

initiating, by the rights issuing system, a billing function after receiving the rights object acquisition acknowledgement message.

In the above method, the validation of the rights object acquisition response message by the Device includes:

validating a signature in the rights object acquisition response message by the Device;

further validating a certificate chain of the rights issuing system when the certificate chain of the rights issuing system is included in the rights object acquisition response message; and

further validating an OCSP response when the OCSP response is included in the rights object acquisition response message.

Before sending to a Device a rights object acquisition response message by a rights issuing system, the above method further includes:

sending a rights object acquisition request message to the rights issuing system by the Device.

In the above method, after sending the rights object acquisition acknowledgement message by the Device, if no transmission error information of the rights object acquisition acknowledgement message is received, then the rights object is installed; otherwise, the installation of the rights object is abandoned.

In the above method, before initiating the billing function, the rights issuing system further validates the rights object acquisition acknowledgement message in accordance with parameter values in the rights object acquisition acknowledgement message; and if the validation fails, then the billing function is not initiated, and transmission error information of the rights object acquisition acknowledgement message is sent to the Device; otherwise, the billing function is initiated.

To attain the above object, in another embodiment of the invention there is further provided an apparatus including a transmission module, a reception module, a validation module, and an installation module;

the transmission module is adapted to transmit a rights object acquisition acknowledgement message, or to transmit a rights object acquisition request message and a rights object acquisition acknowledgement message;

the reception module is adapted to receive a rights object acquisition response message responding to the rights object acquisition request message, the rights object acquisition response message includes a rights object;

the installation module is adapted to install the rights object received by the reception module; and

the validation module is adapted to validate the rights object acquisition response message, and to instruct the transmission module to transmit the rights object acquisition acknowledgement message after the validation succeeds.

The above apparatus further includes a confirmation module, which is adapted to instruct the installation module to install the rights object, when it's confirmed that the reception module receives no transmission error information of the rights object acquisition acknowledgment message.

To attain the above object, in an embodiment there is further provided a rights issuing system including a transmission module, a reception module and a billing function module;

the reception module is adapted to receive a rights object acquisition request message and a rights object acquisition acknowledgement message;

the transmission module is adapted to transmit a corresponding rights object acquisition response message in accordance with the rights object acquisition request message; and

the billing function module is adapted to perform billing for a rights object requester after receiving the rights object acquisition acknowledgement message.

The above rights issuing system further includes:

a validation module, which is adapted to validate the rights object acquisition acknowledgement message, and to instruct the billing function module to initiate billing if the validation succeeds, or to instruct the billing function module not to initiate billing, and to send transmission error information of the rights object acquisition acknowledgement message to the Device if the validation fails.

To attain the above object, in another embodiment of the invention there is provided a method for realizing accurate billing in digital rights management, including:

sending a join domain request message to a rights issuing system by a Device;

returning a join domain response message to the Device by the rights issuing system;

sending a join domain acknowledgement message to the rights issuing system by the Device, after validation of the join domain response message is passed; and

initiating a billing function by the rights issuing system, after receiving the join domain acknowledgement message.

In the above method, the validation of the join domain response message by the Device includes:

validating a signature in the rights object acquisition response message by the Device;

validating a certificate chain of the rights issuing system when the certificate chain of the rights issuing system is included in the rights object acquisition response message; and

validating an OCSP response when the OCSP response is included in the rights object acquisition response message.

In the above method, after sending the join domain acknowledgement message, if no transmission error information of the join domain acknowledgement message is received, then the Device establishes a domain context in accordance with received domain information; otherwise, the establishment of the domain context is abandoned.

In the above method, before initiating the billing function, the rights issuing system further validates the join domain acknowledgement message in accordance with the parameter values in the join domain acknowledgement message; and if the validation fails, then the billing function is not initiated, and transmission error information of the join domain acknowledgement message is sent to the Device; otherwise, the billing function is initiated.

To attain the above object, in another embodiment of the invention there is further provided an apparatus including a transmission module, a reception module, a validation module, and an installation module;

the transmission module is adapted to transmit a join domain request message and a join domain acknowledgement message;

the reception module is adapted to receive a join domain response message responding to the join domain request message;

the installation module is adapted to establish a domain context in accordance with the domain information in the join domain response message; and

the validation module is adapted to validate the join domain response message, and to instruct the transmission module to transmit the join domain acknowledgement message after the validation succeeds.

The above apparatus further includes a confirmation module, which is adapted to instruct the installation module to establish a domain context, when it's confirmed that the reception module receives no transmission error information of the join domain acknowledgment message.

To attain the above object, in another embodiment of the invention there is further provided a rights issuing system including a transmission module, a reception module and a billing function module;

the reception module is adapted to receive a join domain request message and a join domain acknowledgement message;

the transmission module is adapted to transmit a join domain response message in accordance with the join domain request message; and

the billing function module is adapted to perform billing for a join domain requester after receiving the join domain acknowledgement message.

The above rights issuing system further includes:

a validation module, which is adapted to validate the join domain acknowledgement message, and to instruct the billing function module to initiate billing if the validation succeeds, or to instruct the billing function module not to initiate billing, and to send transmission error information of the join domain acknowledgement message to the Device, if the validation fails.

The embodiments of the invention attain the following advantageous effects.

1. Since the rights issuing system initiates billing operation only after receiving a rights object acquisition acknowledgement message from the Device, the accuracy of OMA DEM billing can be improved. Also, the Device installs the received rights object after the rights object acquisition acknowledgement message is sent and in the case that no error in transmitting the acknowledgement message occurs, thus the case in which the rights issuing system leaves out billing due to the loss of the acknowledgement message in transmission can be eliminated.

2. In the event that the rights issuing system charges for the successful joining a domain by the Device, the rights issuing system initiates the billing function after receiving an acknowledgement message of joining the domain by the Device, and thus the accuracy of OMA DEM billing can be improved. Also, the Device is able to establish a domain context in accordance with the received domain information after a DomainInfo ACK message is sent and in the case that no transmission error is received, and therefore a domain-right object can be installed and the right of consuming digital contents controlled by the domain-right object can be obtained, thereby preventing the case in which the rights issuing system does not initiate the billing while the Device may consume digital contents controlled by the domain-right object due to the loss of the acknowledgement message in transmission, and thus making an OMA DRM billing solution more fair and reasonable.

### BRIEF DESCRIPTION OF THE DRAWINGS

FIG. 1 is a flow chart of executing a 2-pass rights object acquisition protocol in the existing ROAP;

FIG. 2 is a flow chart of executing a 1-pass rights object acquisition protocol in the existing ROAP;

FIG. 3 is a flow chart of executing a 2-pass join domain protocol in the existing ROAP;

FIG. 4 is a flow chart of executing a 2-pass rights object acquisition protocol in a first embodiment of the invention;

FIG. 5 is a schematic diagram of the structure of an apparatus in the first embodiment of the invention;

FIG. 6 is a schematic diagram of the structure of a rights issuing system in the first embodiment of the invention;

FIG. 7 is a flow chart of executing a 2-pass join domain protocol in a second embodiment of the invention;

FIG. 8 is a schematic diagram of the structure of an apparatus in the second embodiment of the invention; and

FIG. 9 is a schematic diagram of the structure of a rights issuing system in the second embodiment of the invention;

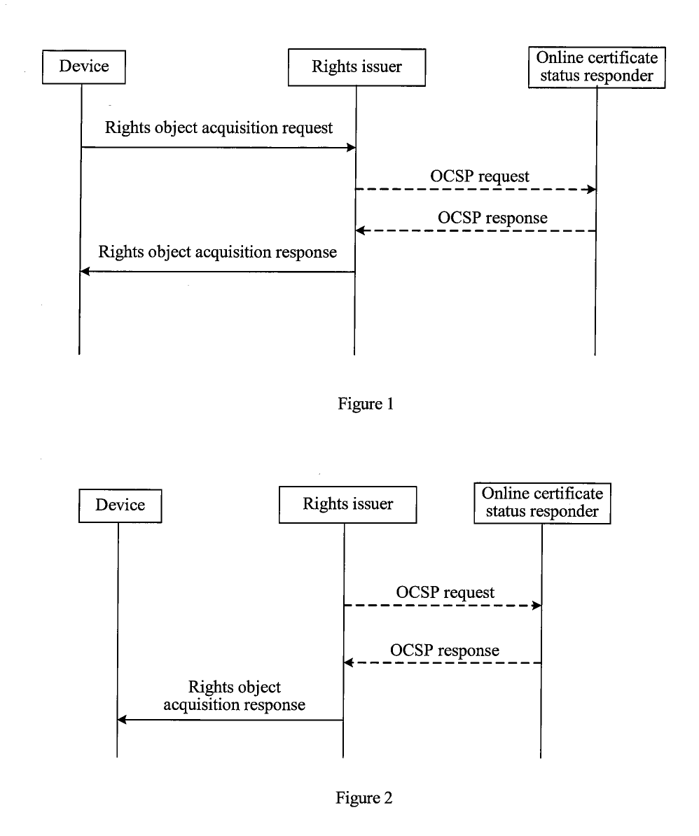

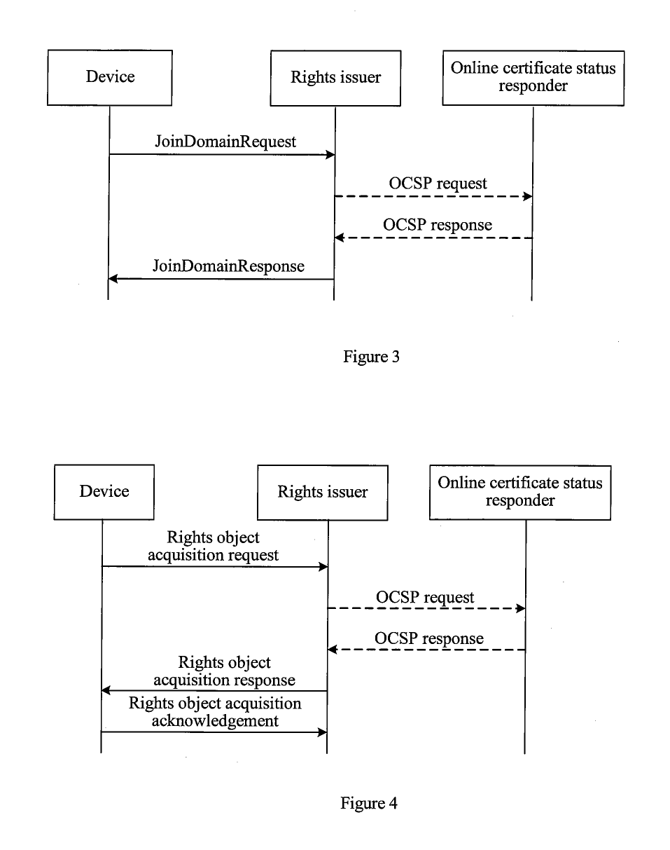

### DETAILED DESCRIPTION OF THE EMBODIMENTS

In order to ensure that a billing behavior occurs in the event that a user has obtained the right of using digital contents indeed, in addition to the 2-pass rights object acquisition protocol and the 1-pass rights object acquisition protocol, a Rights Object Acquisition Acknowledgement message (RO-ACK) is added in the first embodiment of the invention. This message is sent to a Rights issuer—also called a rights issuing system—after a Device receives a rights object correctly, that is, the rights object acquisition protocol is executed successfully. The rights issuing system validates parameter of the RO ACK message after receiving the RO ACK message. If the validation succeeds, then functions such as billing, statistics, etc. are initiated.

Similarly, in addition to the 2-pass join domain protocol, a Join Domain Acknowledgement message (DomainInfo ACK) is added in the second embodiment of the invention. This message is sent to the rights issuing system by the Device after the domain information is received correctly. The rights issuing system validates parameter of the DomainInfo ACK message after receiving the DomainInfo ACK message, and initiates functions such as billing, statistics, etc. when the validation succeeds.

### The First Embodiment

This embodiment will be described in details by an example of a procedure for obtaining a rights object.

With reference to FIG. 4, the procedure of acquiring a rights object by a Device is as follows.

Messages between the Device and the rights issuing system are transmitted through the Hyper Text Transfer Protocol (HTTP), and the transfer layer is based on Transfer Control Protocol (TCP).

1. The Device sends to the rights issuing system a Rights Object Acquisition Request message (ROAP-RORequest), for requesting acquisition of a Rights Object (RO). This message is the first message sent by the 2-pass rights object acquisition protocol. Parameters of the RO Request message are illustrated in Table 1.

TABLE 1
ROAP-RORequest

| Parameter | Mandatory/Optional |
|---|---|
| Device ID | M |
| Domain ID | O |
| RI ID | M |
| Device Nonce | M |
| Request Time | M |
| RO Info | M |
| Certificate Chain | O |
| Extensions | O |
| Signature | M |

Wherein:

Device ID: it identifies the requesting Device.

Domain ID: it identifies the domain of a requested rights object, when the RO Request message contains this parameter.

RI ID: it identifies the rights issuing system.

Device Nonce: it is a nonce number selected by the Device, and can be used only once. For each ROAP message that is required to transmit a temporary element, a new nonce number shall be generated each time. A nonce number should be in a length of at least 14-bit Base64 coding character (approximately 80 bits).

Request Time: it is a current DRM time measured by the Device.

RO Info: it identifies a requested rights object. This parameter includes a set of (non-empty) rights object identifiers identifying a requested rights object, and an optional DCF (DRM Content Format) hash carried in each rights object identifier, which is related to the requested rights object.

Certificate Chain: it includes a certificate chain of Device certificate.

Extensions: they are extended parameters defined by the ROAP-RORequest, and include an extended parameter indicative of whether the Device has stored a public key identifier of the rights issuing system or whether the Device has stored an ID of the rights issuing system and a corresponding certificate chain of the rights issuing system, an extended parameter indicative of permitting the Device to provide the rights issuing system with a tracking service, etc.

Signature: it is a signature on data sent through the protocol. The signature is calculated for all the elements (exclude the element of Signature itself) in the message with a private key of the Device.

The Device transmits to the rights issuing system the rights object request message including the Device ID, the Domain ID (optional), the RI ID, the Device Nonce, the Request Time, the RO Info., the Certificate Chain (optional), the Extensions (optional) and the Signature.

The Signature in the ROAP-RORequest message is used for the rights issuing system to validate reliability and integrity of the message.

The Certificate Chain in the ROAP-RORequest message is an optional parameter used for the rights issuing system to validate authenticity of a source.

2. The rights issuing system validates the ROAP-RORequest, and sends to the Device a Rights Object Acquisition Response message (ROAP-ROResponse) carrying a protected rights object. In the 2-pass protocol, the message responds to the ROAP-RORequest message, and in the 1-pass protocol, the message is a message initiated by the rights issuing system. Parameters in the RO Response message are illustrated in Table 2.

TABLE 2

| | ROAP-ROResponse | | |
|---|---|---|---|
| | 2-pass | 2-pass | |
| Parameter | Status = Success | Status ≠ Success | 1-pass |
| Status | M | M | M |
| Device ID | M | — | M |
| RI ID | M | — | M |
| Device Nonce | M | — | — |
| Protected ROs | M | — | M |
| Certificate Chain | O | — | O |
| OCSP Response | O | — | M |
| Extensions | O | — | O |
| Signature | M | — | M |

Status: it indicates whether a request for a rights object has been completed successfully, and if not, an error code may be sent.

Device ID: it identifies the requesting Device, and the returned value should be equal to the value of the Device ID in the ROAP-RORequest message triggering the response in the 2-pass protocol. In the ROAP 1-pass protocol, this parameter should be equal to the value of the Device ID in a request message ROAP-DeviceHello.

RI ID: it identifies the rights issuing system, and the returned value should be equal to the RI ID transmitted by the Device in the ROAP-RORequest message triggering the response in the 2-pass protocol. In the ROAP 1-pass protocol, this parameter should be equal to the value of the RI ID in the ROAP-DeviceHello (i.e. the first message of the ROAP 4-pass registration protocol).

Device Nonce: when this parameter exists (2-pass), the value of it should be identical to the value of the parameter Device Nonce in the previous ROAP-RORequest message.

Protected RO(s): it is a rights object(s) with sensitive information (such as a content key) being encrypted.

Certificate Chain: it includes a certificate chain of rights issuing system certificate.

OCSP Response: it is an OCSP response indicating whether a certificate in the certificate chain of the rights issuing system is valid.

Extensions: they are extended parameters defined by the ROAP-ROResponse message, and are used for indicating that the rights issuing system is permitted to provide the Device with a tracking transaction.

Signature: it is a signature on data sent through the protocol. The signature is calculated for all the elements (exclude the element of Signature itself) in the message with a private key of the rights issuing system.

The rights issuing system sends to the Device the rights object response message including the Device ID, the RI ID, the Device Nonce, the Protected RO(s), the Signature, etc.

The Signature in the ROAP-ROReponse message is used for validating reliability and integrity of the message by the Device.

The parameter Certificate Chain in the ROAP-ROResponse message is used for validating authenticity of a source by the Device.

The parameter OCSP Response in the ROAP-ROResponse message is used for validating, by the Device, the status of the certificate of the rights issuing system, wherein the status includes Available, Expired, Already Revoked, etc.

3. The Device validates the ROAP-ROResponse message, and sends a rights object acknowledgement message (RO-ACK) to the rights issuing system when the validation succeeds. Parameters included in the RO ACK message are illustrated in Table 3.

Here, when the Device validates the ROAP-ROResponse message, the validation succeeds on the following conditions.

a. The validation on the Signature in the ROAP-ROResponse message succeeds;

b. If the ROAP-ROResponse message includes the certificate chain of the rights issuing system, then the certificate chain of the rights issuing system should be validated successfully; and

c. If the ROAP-ROResponse message includes the OCSP Response, then the OCSP

Response should indicate that the certificate of the rights issuing system is in an available status.

If there is no certificate chain of the rights issuing system included in the ROAP-ROResponse message, then the previous ROAP-ROResquest message indicates that the Device has stored the public key identifier of the rights issuing system or the certificate chain of the rights issuing system, that is, the Device has validated and stored information capable of validating validity of the rights issuing system, before the ROAP-ROResquest message is received. In this case, the ROAP-ROResponse message may not necessarily transmit the certificate chain of the rights issuing system.

Similarly, the ROAP-ROResponse message may not necessarily include the parameter OCSP Response. If the Device has buffered a full set of effective OCSP responses for the rights issuing system, then the Device may notify the rights issuing system through the parameter Extensions in the ROAP-RORequest message, and if this information parameter is not neglected by the rights issuing system, then the ROAP-ROResponse may include no OCSP Response.

TABLE 3

RO ACK

| Parameter | 2-pass | 1-pass |
|---|---|---|
| Device ID | M | M |
| RI ID | M | M |
| Device Nonce | M | — |
| Extensions | O | O |
| Signature | M | M |

Device ID: it identifies the requesting Device. The value of this parameter equals to the value of the Device ID in the ROAP-RORequest message of the 2-pass protocol. In the ROAP 1-pass protocol, this parameter equals to the value of the Device ID in the request message ROAP-DeviceHello.

RI ID: it identifies the rights issuing system, and the returned value equals to the value of the RI ID in the ROAP-RORequest message of the 2-pass protocol. In the ROAP 1-pass protocol, this parameter should be equal to the value of the RI ID in the request message ROAP-DeviceHello.

Device Nonce: if this parameter exists (2-pass), then it should be identical to the value of the Device Nonce in the previous ROAP-RORequest message.

Extensions: they are used to define extended parameters for the RO ACK message.

Signature: it is a signature for the message. The signature is calculated for all the elements (exclude the element of Signature itself) in the message with a private key of the Device.

4. The rights issuing system receives the RO-ACK message from the Device, and validates the Signature, the Device Nonce, the Device ID and the RI ID of the RO ACK message. The definitions and values of the parameters are as described above. If the validation succeeds, then the rights issuing system initiates functions of billing, statistics, etc.; otherwise the received RO ACK message is abandoned (not shown in FIG. 4).

For preventing occurrence of the case in which the rights issuing system does not initiate the billing while the Device may consume digital contents due to the loss of the acknowledgement message in transmission, the following configuration may be further provided in the first embodiment of the inventive method: when the RO-ACK message is sent, and no transmission error is received (a transmission error may be captured because the message is transmitted with HTTP and the transfer layer is based on TCP), the received rights object can be installed by the Device; otherwise the received rights object can not be installed. Thus, it can be ensured that the Device is given the right of consuming digital contents only in the case that the acknowledgement message of RO-ACK has been transmitted to and arrived at the rights issuing system.

With above configuration, if the validation of the RO-ACK message fails in step 4, then the rights issuing system may send to the Device the transmission error information of the rights object acquisition acknowledgement message. Thus, the billing is not initiated by the rights issuing system, and the rights object received cannot be installed by the Device.

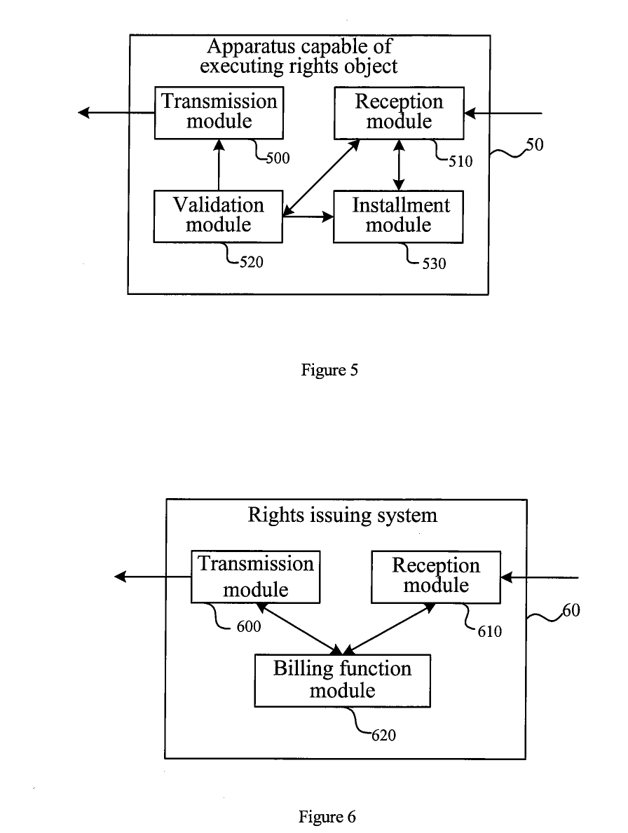

Correspondingly, an apparatus 50 provided in the first embodiment is illustrated in FIG. 5, including a transmission module 500, a reception module 510, a validation module 520 and an installation module 530.

The transmission module 500 is adapted to transmit a rights object acquisition acknowledgement message (in the 1-pass protocol) or to transmit a rights object acquisition request message and a rights object acquisition acknowledgement message (in the 2-pass protocol).

The reception module 510 is adapted to receive a rights object acquisition response message including a rights object.

The validation module 520, which is logically connected with the transmission module 500 and the reception module 510, is adapted to validate the rights object acquisition response message, and to instruct the transmission module 500 to transmit the rights object acquisition acknowledgement message when the validation succeeds.

The installation module 530, which is logically connected with the reception module 510 and the validation module 520, is adapted to install a rights object received by the reception module.

The installation module 530 installs the rights object in the case that the reception module 510 receives no transmission error information of the rights object acquisition acknowledgement message transmitted from the transmission module 500.

Therefore, the Device may further include a confirmation module, which is adapted to instruct the installation module to install the rights object, when it's confirmed that no transmission error information of the rights object acquisition acknowledgement message is received by the reception module.

A rights issuing system 60 provided in the first embodiment is illustrated in FIG. 6, including a transmission module 600, a reception module 610 and a billing function module 620.

The reception module 610 is adapted to receive a rights object acquisition request message and a rights object acquisition acknowledgement message.

The transmission module 600 is adapted to transmit a corresponding rights object acquisition response message in accordance with a rights object acquisition request message (in the 2-pass protocol), or to transmit a corresponding rights object acquisition response message (in the 1-pass protocol).

The billing function module 620, which is logically connected with the transmission module 600 and the reception module 610, is adapted to perform the billing for the rights object requester after receiving a rights object acquisition acknowledgement message.

The rights issuing system in the first embodiment of the invention may further include a validation module, which is adapted to validate a rights object acquisition acknowledgement message, and which is adapted to instruct the billing function module to initiate the billing when the validation succeeds, or to instruct the billing function module not to initiate the billing and to send transmission error information of the rights object acquisition acknowledgement message to the Device when the validation fails.

Through adding the confirmation step in the rights object acquisition procedure after the rights object has been obtained by the Device successfully, it is ensured that the billing behavior occurs in the event that the user has obtained correctly the rights object indeed. Also, the Device may be configured to be enabled to install the received rights object when the rights object acquisition acknowledgement message has been sent and no error occurs in transmitting the acknowledgement message, thereby the situation in which the rights issuing system leaves out billing due to the loss of the acknowledgement message in transmission may be eliminated.

### The Second Embodiment

This embodiment will be described in details with an example of a procedure for joining a domain.

Messages between the Device and the rights issuing system are transmitted through the Hyper Text Transfer Protocol (HTTP), and the transfer layer is based on Transfer Control Protocol (TCP).

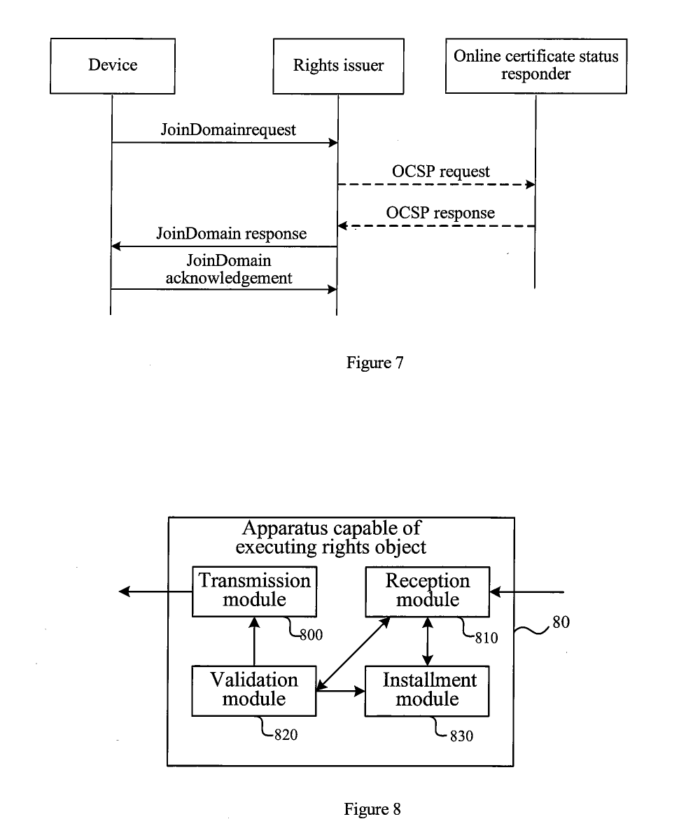

With reference to FIG. 7, the Device joins a domain with the following procedure.

1. The Device sends to the rights issuing system a join domain request message (ROAP-JoinDomainRequest), which is the first message of the 2-pass join domain protocol, and which supports the request for joining a single domain. Parameters included in the JoinDomainRequest message are illustrated in Table 4.

TABLE 4
ROAP-JoinDomainRequest

| Parameter | Mandatory/Optional |
|---|---|
| DeviceID | M |
| RI ID | M |
| Device Nonce | M |
| Request Time | M |
| Domain Identifier | M |
| Certificate Chain | O |
| Extensions | O |
| Signature | M |

Device ID: it identifies the requesting Device.

RI ID: it identifies the rights issuing system.

Device Nonce: it is a nonce number selected by the Device, and should be used only once. For each ROAP message that is required to transmit a temporary element, a new nonce number shall be generated each time. A nonce number should be in a length of at least 14-bit Base64 coding character (approximately 80 bits).

Request Time: it is the current DRM time measured by the Device.

Domain Identifier: it identifies a domain requested for joining by the Device.

Certificate Chain: it includes a certificate chain of Device certificate.

Extensions: they are extended parameters defined by the ROAP-JoinDomainRequest, and include an extended parameter indicative of whether the Device has stored a certificate chain of the rights issuing system, an extended parameter indicative of that the rights issuing system uses a technology of generating a domain private key with a hash chain, etc.

Signature: it is a signature on data sent through the protocol. The signature is calculated for all the elements (exclude the element of Signature itself) in the message with a private key of the Device.

The Device transmits to the rights issuing system the join domain request message including the Device ID, the RI ID, the Domain Identifier, the Device Nonce, the Request Time, the Signature, etc.

The Signature in the ROAP-JoinDomainRequest message is used for validating reliability and integrity of the message by the rights issuing system.

The parameter Certificate Chain in the ROAP-JoinDomainRequest message is an optional parameter used for validating authenticity of a source by the rights issuing system.

2. The rights issuing system validates the ROAP-JoinDomainRequest, and sends to the Device a join domain response message (ROAP-JoinDomainResponse), which is the second message in the 2-pass protocol for joining a domain by the Device. Parameters included in the message are illustrated in Table 5.

TABLE 5

ROAP-JoinDomainResponse

| Parameter | Status = “Success” | Status ≠ “Success” |
|---|---|---|
| Status | M | M |
| Device ID | M | — |
| RI ID | M | — |
| Device Nonce | M | — |
| Domain Info | M | — |
| Certificate chain | O | — |
| OCSP Response | O | — |
| Extensions | O | — |
| Signature | M | — |

Status: it indicates whether a request for joining a domain has been completed successfully, and if not, an error code may be sent.

Device ID: it identifies the requesting Device, and the value of this parameter should be equal to the value of the Device ID in the ROAP-JoinDomainRequest message triggering the response in the 2-pass protocol.

RI ID: it identifies the rights issuing system, and the returned value should be equal to the RI ID transmitted by the Device in the ROAP-JoinDomainRequest message triggering the response in the 2-pass protocol.

Device Nonce: the value of this parameter should be identical to the value of the parameter Device Nonce in the previous ROAP-JoinDomainResponse message.

Domain Info: this parameter carries a domain private key (encrypted with a public key of the Device) and information of the maximum lifetime of a domain. The actual service time of the Device may be shorter than the lifetime suggested by the rights issuing system.

Certificate Chain: it includes a certificate chain of rights issuing system certificate.

OCSP Response: it is an OCSP response indicating whether a certificate in the certificate chain of the rights issuing system is valid.

Extensions: they are extended parameters defined by the ROAP-JoinDomainResponse message, and indicate that the rights issuing system currently uses a technology of generating a domain private key with a hash chain.

Signature: it is a signature on data sent through the protocol. The signature is calculated for all the elements (exclude the element of Signature itself) in the message with a private key of the rights issuing system.

The rights issuing system sends to the Device the join domain response message including the Device ID, the RI ID, the Device Nonce, the Domain Info, the Signature, etc.

The Signature in the ROAP-JoinDomainResponse message is used for validating reliability and integrity of the message by the Device.

The parameter Certificate Chain in the ROAP-JoinDomainResponse message is used for validate authenticity of a source by the Device.

The parameter OCSP Response in the ROAP-JoinDomainResponse message is used for validating the status of the certificate of the rights issuing system by the Device, the status includes Available, Expired, Already Revoked, etc.

3. The Device validates the ROAP-JoinDomainResponse message, and sends a join domain acknowledgement message (DomainInfo ACK) to the rights issuing system when the validation succeeds. The domain private key and the information of the maximum lifetime of a domain carried in the parameter Domain Info of the ROAP-JoinDomainResponse are key information for establishing a domain context. The Device can install and use a domain rights object only if a domain context is established successfully. Parameters included in the DomainInfo ACK message are illustrated in Table 6.

Here, when the Device validates the ROAP-JoinDomainResponse message, the validation succeeds on the following conditions.

a. The validation on the Signature in the ROAP-JoinDomainResponse message succeeds;

b. If the ROAP-JoinDomainResponse message includes the Certificate Chain of the rights issuing system, then the Certificate Chain of the rights issuing system is validated successfully;

c. If the ROAP-JoinDomainResponse message includes the OCSP Response, the OCSP Response indicates that the certificate of the rights issuing system is available.

TABLE 6
DomainInfo ACK

| Parameter | Mandatory/Optional |
|---|---|
| DeviceID | M |
| RI ID | M |
| Device Nonce | M |
| Domain Identifier | M |
| Extensions | O |
| Signature | M |

Device ID: it identifies the requesting Device. The value of this parameter should be equal to the value of the Device ID in the ROAP-JoinDomainRequest message of the 2-pass protocol.

RI ID: it identifies the rights issuing system, and that the returned value should be equal to the value of the RI ID in the ROAP-JoinDomainRequest message of the 2-pass protocol.

Device Nonce: the value of this parameter should be identical to the value of the parameter Device Nonce in the previous ROAP-JoinDomainRequest message.

Domain Identifier: it identifies a domain requested for joining by the Device. The value of this parameter should be identical to the value of the parameter Domain Identifier in the previous ROAP-JoinDomainRequest.

Extensions: they are used to define extended parameters for the DomainInfo ACK message.

Signature: it is a signature for the message. The signature is calculated for all the elements (exclude the element of Signature itself) in the message with a private key of the Device.

4. The rights issuing system receives the DomainInfo ACK message from the Device, and validates the Signature, the Device Nonce, the Device ID, the RI ID and the Domain Identifier of the DomainInfo ACK message. The definitions and values of the parameters are as described above. If the validation succeeds, then the rights issuing system initiates functions of billing, statistics, etc.; otherwise the received DomainInfo ACK message is abandoned.

Moreover, for preventing occurrence of the case in which the rights issuing system does not initiate the billing, while the Device may consume digital contents controlled by the domain rights object due to the loss of the acknowledgement message in transmission, the following configuration may be further provided in the second embodiment of the invention: when the DomainInfo ACK message is sent, and no transmission error is received (a transmission error can be captured because the message is transmitted with HTTP and the transfer layer is based on TCP), the Device can establish a domain context in accordance with the received domain information, and thus can install the domain rights object and obtain the right of consuming digital contents controlled by the domain rights object; otherwise, the Device can neither store the received domain information nor establish a domain context. Thus, it can be ensured that the Device is given the right of consuming digital contents controlled by the domain rights object in the case that the acknowledgement message of DomainInfo ACK has been transmitted to and arrived at the rights issuing system, thereby avoiding the case in which the rights issuing system does not initiate the billing while the Device can consume digital contents controlled by the domain rights object due to the loss of the acknowledgement message in transmission.

With the above configuration, if the validation of the DomainInfo ACK message fails in step 4 of the second embodiment, then the rights issuing system may send to the Device transmission error information of the DomainInfo ACK message. Thus, the rights issuing system does not initiate the billing, and the Device can not establish a domain context.

In the above solution, through adding, in the procedure of joining a domain, the confirmation step after the Device has obtained successfully the information for establishing a domain context, it is thus ensured that the billing behavior will occur in the event that the Device has obtained correctly the domain information indeed. Also, the Device is configured to be able to install the received domain information only after the acknowledgement message indicative of a successful establishment of a domain context is sent and no error in transmitting the acknowledgement message occurs (so that the domain rights object can be installed), thereby the case in which the rights issuing system leaves out billing due to the loss of the acknowledgement message in transmission can be avoided.

Correspondingly, an apparatus 80 provided in the second embodiment is illustrated in FIG. 8, including a transmission module 800, a reception module 810, a validation module 820 and an installation module 830.

The transmission module 800 is adapted to transmit a join domain request message and a join domain acknowledgement message.

The reception module 810 is adapted to receive a join domain response message.

The validation module 820, which is logically connected with the transmission module 800 and the reception module 810, is adapted to instruct the transmission module 800 to transmit the join domain acknowledgement message when the validation of the join domain response message succeeds.

The installation module 830, which is logically connected with the reception module 810 and the validation module 820, is adapted to establish a domain context in accordance with the domain information in the join domain response message. Furthermore, the installation module 830 establishes a domain context in the case that the transmission module 800 has sent the join domain acknowledgement message and receives no transmission error information of the join domain acknowledgement message.

Therefore, the apparatus may further include a confirmation module, which is adapted to instruct the installation module to establish a domain context, when it's confirmed that the reception module receives no transmission error information of the join domain acknowledgement message.

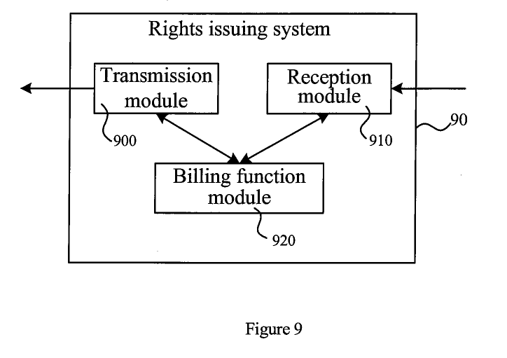

With reference to FIG. 9, a rights issuing system provided in the second embodiment includes a transmission module 900, a reception module 910 and a billing function module 920, wherein:

The reception module 910 is adapted to receive a join domain request message and a join domain acknowledgement message.

The transmission module 900 is adapted to transmit a corresponding join domain response message in accordance with a join domain request message.

The billing function module 920, which is logically connected with the reception module 910 and the transmission module 900, is adapted to perform the billing for the join domain requester after receiving a join domain acknowledgement message.

In the case that the rights issuing system charges for the successful joining a domain by the Device, the security of the OMA DRM billing can be improved by adding the confirmation step in the procedure of joining a domain after the Device has obtained successfully the domain information.

Moreover, the rights issuing system may further include a validation module, which is adapted to validate a join domain acknowledgement message, and is adapted to instruct the billing function module to initiate the billing when the validation succeeds; or to instruct the billing function module not to initiate the billing and to send transmission error information of the join domain acknowledgement message to the Device when the validation fails.

In the embodiments of the invention, a trust relationship between the rights issuing system and the Device is established based upon an OMA DRM trust model. The OMA DRM trust model is based upon a Public Key Infrastructure (PKI). If the validation on a DRM proxy certificate performed by the rights issuing system succeeds and is not revoked, the rights issuing system trusts that the Device is able to behavior correctly. Alike, if the validation on the certificate of the rights issuing system performed by the DRM proxy succeeds and is not revoked, the Device trusts that the rights issuing system is able to behavior correctly.

It shall be obvious that various modifications and variations can be made to the present invention by those skilled in the art without departing from the spirit and scope of the invention. Therefore, the invention is intended to encompass all the modification and variations provided that they fall within the scope of the invention as defined in the accompanying claims and equivalents.

What is claimed is:

1. A method for realizing accurate billing in digital rights management, comprising:
sending, by a rights issuing system, a rights object acquisition response message including a rights object to a Device;
receiving, by the rights issuing system, a rights object acquisition acknowledgement message from the Device, after validation on the rights object acquisition response message performed by the Device succeeds; and
initiating, by the rights issuing system, a billing function after receiving the rights object acquisition acknowledgement message.

2. The method according to claim 1, wherein performing the validation on the rights object acquisition response message by the Device comprises:
validating a signature in the rights object acquisition response message by the Device;
further validating a certificate chain of the rights issuing system when the certificate chain of the rights issuing system is included in the rights object acquisition response message; and
further validating an Online Certificate State Protocol (OCSP) response when the OCSP response is included in the rights object acquisition response message.

3. The method according to claim 1, further comprising: before sending, by the rights issuing system, the rights object acquisition response message to the Device,
sending a rights object acquisition request message to the rights issuing system by the Device.

4. The method according to claim 1, further comprising: after the Device sends the rights object acquisition acknowledgement message, if no transmission error information of the rights object acquisition acknowledgement message is received, installing the rights object; otherwise, abandoning installing the rights object.

5. The method according to claim 1, further comprising: before initiating the billing function, further validating, by the rights issuing system, the rights object acquisition acknowledgement message in accordance with parameter values in the rights object acquisition acknowledgement message; if the validation fails, the billing function is not initiated, and transmission error information of the rights object acquisition acknowledgement message is sent to the Device; otherwise, the billing function is initiated.

6. The method according to claim 5, wherein the parameter values comprise a Device identifier, a rights issuing system identifier, a nonce number, and a message signature.

7. An apparatus comprising:
a transmission module, adapted to transmit a rights object acquisition acknowledgement message, or to transmit a rights object acquisition request message and a rights object acquisition acknowledgement message;
a reception module, adapted to receive a rights object acquisition response message responding to the rights object acquisition request message, wherein the rights object acquisition response message includes a rights object;
an installation module, adapted to install the rights object received by the reception module; and
a validation module, adapted to validate the rights object acquisition response message, and to instruct the transmission module to transmit the rights object acquisition acknowledgement message after the validation succeeds.

8. The apparatus according to claim 7, further comprising:
a confirmation module adapted to instruct the installation module to install the rights object when it is confirmed that the reception module receives no transmission error information of the rights object acquisition acknowledgment message.

9. A rights issuing system comprising:
a reception module, adapted to receive a rights object acquisition request message and a rights object acquisition acknowledgement message;
a transmission module, adapted to transmit a corresponding rights object acquisition response message in accordance with the rights object acquisition request message; and
a billing function module, adapted to perform billing for a rights object requester after receiving the rights object acquisition acknowledgement message.

10. The rights issuing system according to claim 9, further comprising:
a validation module, adapted to validate the rights object acquisition acknowledgement message, and to instruct the billing function module to initiate billing if the validation succeeds, or to instruct the billing function module not to initiate billing and send transmission error information of the rights object acquisition acknowledgement message to the Device if the validation fails.

11. A method for realizing accurate billing in digital rights management, comprising:
receiving, by a rights issuing system, a join domain request message from a Device;
returning, by the rights issuing system, a join domain response message to the Device;
receiving, by the rights issuing system, a join domain acknowledgement message from the Device, after validation on the join domain response message performed by the Device succeeds; and
initiating a billing function by the rights issuing system, after receiving the join domain acknowledgement message.

12. The method according to claim 11, wherein the validation on the join domain response message by the Device comprises:
validating a signature in the rights object acquisition response message by the Device;
validating a certificate chain of the rights issuing system when the certificate chain of the rights issuing system is included in the rights object acquisition response message; and
validating an Online Certificate State Protocol (OCSP) response when the OCSP response is included in the rights object acquisition response message.

13. The method according to claim 11, further comprising: after the join domain acknowledgement message is sent, if no transmission error information of the join domain acknowledgement message is received, establishing, by the Device, a domain context in accordance with received domain information; otherwise, abandoning the establishment of the domain context.

14. The method according to claim 11, further comprising: before initiating the billing function, further validating, by the rights issuing system, the join domain acknowledgement message in accordance with parameter values in the join domain acknowledgement message; if the validation fails, the billing function is not initiated, and transmission error information of the join domain acknowledgement message is sent to the Device; otherwise, the billing function is initiated.

15. The method according to claim 14, wherein the parameter values comprise a Device identifier, a rights issuing system identifier, a nonce number, a domain identifier and a message signature.

16. An apparatus comprising:
a transmission module, adapted to transmit a join domain request message and a join domain acknowledgement message;
a reception module, adapted to receive a join domain response message responding to the join domain request message;
an installation module, adapted to establish a domain context in accordance with the domain information in the join domain response message; and
a validation module, adapted to validate the join domain response message, and to instruct the transmission module to transmit the join domain acknowledgement message after the validation succeeds.

17. The apparatus according to claim 16, further comprising:
a confirmation module, adapted to instruct the installation module to establish a domain context, when it is confirmed that the reception module receives no transmission error information of the join domain acknowledgment message.

18. A rights issuing system comprising:
a reception module, adapted to receive a join domain request message and a join domain acknowledgement message;
a transmission module, adapted to transmit a join domain response message in accordance with the join domain request message; and
a billing function module, adapted to perform billing for a join domain requester after receiving the join domain acknowledgement message.

19. The rights issuing system according to claim 18, further comprising:
a validation module, adapted to validate the join domain acknowledgement message, and to instruct the billing function module to initiate billing if the validation succeeds, or to instruct the billing function module not to initiate billing, and to send transmission error information of the join domain acknowledgement message to the Device, if the validation fails.

20. An accurate billing system, comprising:
a Device, adapted to send a rights object acquisition acknowledgement message after validation on a rights object acquisition response message succeeds; and
a rights issuing system, adapted to initiate a billing function after receiving the rights object acquisition acknowledgement message;
wherein the rights object acquisition response message including a rights object is sent by the rights issuing system to the Device.

21. An accurate billing system, comprising:
a Device, adapted to send a join domain request message; and
a rights issuing system, adapted to return a join domain response message and initiate a billing function after receiving a join domain acknowledgement message;
wherein the join domain acknowledgement message is sent by the Device after validation on the join domain response message succeeds.
